(19) United States
(12) Patent Application Publication
(10) Pub. No.: US 2025/0264385 A1
(43) Pub. Date: Aug. 21, 2025

(54) MEDIUM AND DEVICE FOR PROTEOMIC SAMPLE PREPARATION

(71) Applicant: UNIVERSITY OF DELAWARE, Newark, DE (US)

(72) Inventor: Yanbao YU, Avondale, PA (US)

(73) Assignee: UNIVERSITY OF DELAWARE, Newark, DE (US)

(21) Appl. No.: 18/859,334

(22) PCT Filed: Apr. 27, 2023
(86) PCT No.: PCT/US2023/020215

§ 371 Date: Oct. 23, 2024

Related U.S. Application Data
(60) Provisional application No. 63/335,238, filed on Apr. 27, 2022.

(51) Int. Cl. G01N 1/34; G01N 1/30; G01N 1/31

(52) U.S. Cl. CPC G01N 1/34; G01N 1/30; G01N 1/31; G01N 2001/307

(57) ABSTRACT

The invention provides a medium. The medium comprises a fibrous matrix and silica microparticles immobilized in the fibrous matrix. The fibrous matrix may comprise glass fibers, polyolefin fibers, polyvinylidene fluoride (PVDF) fibers, polytetrafluoroethylene (PTFE) fibers, polypropylene fibers, polyethylene fibers, aramid fibers, natural cellulosic fibers, or a combination thereof. A composition comprising the medium is provided. A device comprising the medium or the composition is also provided. Further provided are methods for preparing a proteomic sample from a biological sample on the medium. The biological sample comprises cells or proteins. The method may comprise a treating step, a digesting step, a reducing and alkylating step, and an eluting step. All of these steps may be performed on the medium. The proteomic sample comprises the eluted peptides. The proteomic sample may be desalted. The peptides prepared from the biological sample may be suitable for qualitative or quantitative analysis, for example, mass spectrometric analysis.

### CROSS-REFERENCE TO RELATED APPLICATION

This application claims priority to U.S. Provisional Application No. 63/335,238, filed Apr. 27, 2022, and the contents of which are incorporated herein by reference in their entireties for all purposes.

### REFERENCE TO U.S. GOVERNMENT SUPPORT

This invention was made with government support under Grant No. P20GM104316 from the National Institute of General Medical Sciences (NIGMS). The United States has certain rights in the invention.

### FIELD OF THE INVENTION

This invention relates generally to a medium useful for preparing a proteomic sample.

### BACKGROUND OF THE INVENTION

The ultimate goal of a proteomics analysis is to analyze the entire proteome of a biological sample, so the biology and/or pathology-relevant molecules and marker proteins, especially those in low abundance, could be revealed. The samples may be derived from cells, tissues, and other types of biospecimens, or isolated complexes (e.g., secreted vesicles, subcellular organelles, or complexes from affinity purification). Therefore, a major component of the shotgun proteomics experiment is protein extraction followed by proteolytic digestion.

For protein extraction from cells and tissues, it is critical to achieve unbiased protein extraction with a high yield. A variety of chemical such as sodium dodecyl sulfate (SDS), urea and trifluoroacetic acid (TFA), and physical disruption methods such as sonication, bead-beating and homogenization have been employed. For protein digestion, it could occur in solution or on a solid support such as a gel matrix, a membrane filter, and microbeads. In-solution digestion, although straightforward, limits the selection of detergents to acid labile and MS-compatible detergents only. The in-gel digestion approach has been one of the most conventional ways of preparing samples for proteomics analysis. However, it associates with limitations of poor recovery, low throughput and labor intense. The new trend of the proteomics field is gel-free filter-based single-vessel methods.

Membrane can serve as a support medium for filter-based sample processing. Reported applications include glass and quartz microfiber (Whatman™, Cytiva), polyethersulfone (PES) (Omega™ membrane, Pall Corporation), regenerated cellulose (Hydrosart®), Sartorius AG; Ultracel® membrane, MilliporeSigma), polyvinylidene fluoride (PVDF) (MultiScreen® plate, MilliporeSigma), and hybrid membrane such as particle-loaded polytetrafluoroethylene (PTFE) membrane (Empore™ membranes, CDS Analytical LLC). In these applications, proteins are captured onto the membrane via size-based retention or binding, followed by washing (to deplete interfering chemicals and obtain digestion-compatible proteins), proteolytic digestion, and subsequent peptide elution. However, these methods suffer from either high cost or suboptimal performance in the context of protein yield, digestion efficiency, quantitation accuracy, speed and universality.

Microparticles such as paramagnetic beads and glass beads can also serve as a support medium for proteomic sample processing, which are the so-called on-bead methods. In these methods, proteins are first precipitated onto the surface of particles by organic solvents such as acetonitrile, and are then subjected to washing, protein digestion, and peptide elution. Unfortunately, the on-bead methods require fine-tuning of the experimental procedures in the context of pH, protein concentration, and protein-bead ratios. Meanwhile, extra cautions are required to avoid potential sample loss to tube walls and pipette tips, unintentional disruption of protein aggregates, inconsistent aliquoting of bead suspensions or insufficient distribution of beads due to rapid sedimentation, and possible cross contaminations during automation, all of which increase its technical barrier for adoption by non-expert scientists.

The current field of proteomics lacks a universal sample preparation methodology that combines robustness, cost-effectiveness, and high efficiency for cell lysis, protein cleanup, and digestion.

### SUMMARY OF THE INVENTION

The inventors have discovered a medium for preparation of a proteomic sample from a biological sample. The proteomic sample comprises peptides prepared from the biological sample, and is suitable for analysis, for example, by mass spectrometry.

A medium is provided. The medium comprises a fibrous matrix and silica microparticles immobilized in the fibrous matrix.

The fibrous matrix may comprise polytetrafluoroethylene (PTFE) fibers, glass fibers, polypropylene fibers, polyolefin fibers, polyvinylidene fluoride (PVDF) fibers, natural cellulosic fibers, polyethylene fibers, aramid fibers, or a combination thereof.

The silica microparticles may be non-porous glass beads. The silica microparticles may have an irregular shape or a spherical shape. The silica microparticles may have a size of 0.1-600 micrometers. The silica microparticles may have a weight percentage of greater than 30% based on the total weight of the medium.

The medium may further comprise a non-swellable particulate material.

The medium may be in the form of a sheet, square, oval, circular disk, or a combination thereof. The medium may be in the form of one or more self-supporting sheets, squares, ovals, circular disks, or combinations thereof. The medium may be in the form of two or more self-supporting sheets, squares, ovals, circular disks, or combinations thereof. The two or more self-supporting sheets, squares, ovals, circular disks, or combinations thereof may have edges attached. The medium may be in the form of a multi-layered composite film.

A composition is provided. The composition comprises a support and the medium of the present invention, and the medium is adhered to the support. The composition may further comprise an additional fibrous matrix.

A device is provided. The device comprises a reaction chamber and the medium of the present invention or the composition of the present invention, and the medium is in the reaction chamber. The reaction chamber may be formed by a pipette tip, cartridge, multi-well plate, or container.

A method is provided for preparing a proteomic sample from proteins in a biological sample on the medium of the present invention. The method comprises: (a) treating the biological sample on the medium with a solvent to produce a treatment mixture on the medium, wherein the treatment mixture comprises the proteins on the medium; (b) digesting the proteins on the medium with a proteolytic enzyme to produce peptides on the medium; (c) reducing and alkylating the treatment mixture on the medium; and (d) eluting the peptides from the medium in an elution, whereby a proteomic sample comprising the eluted peptides is prepared. The method may further comprise desalting the proteomic sample. The proteins may be digested before the treatment mixture is reduced and alkylated. The proteins may be digested after the treatment mixture is reduced and alkylated.

The method may further comprise washing the biological sample on the medium.

The method may further comprise repeating the eluting step one or more times to produce one or more additional elutions.

Where the biological sample comprises cells and the proteins are in the cells, the method may further comprise extracting the proteins from the cells. The proteins may be extracted from the cells on the medium.

Where the biological sample comprises cells and the proteins are in the cells, the method may further comprise fixing the cells.

The solvent may be selected from the group consisting of methanol, chloroform, acetonitrile, acetone, ammonium sulfate, trichloroacetic acid and a combination thereof.

The treating step may comprise incubating the biological sample with a solvent at a temperature of 0-4° C. for 0.1-24 hours.

The proteolytic enzyme may be selected from the group consisting of trypsin, Lys-C, chymotrypsin, Glu-C, Arg-C, Asp-N, proteinase K, elastase, and a combination thereof.

The reducing and alkylating step may comprise subjecting the treatment mixture on the medium to a reducing reagent and an alkylation reagent. The reducing reagent may be dithiothreitol, beta-mercaptoethanol or Tris (2-carboxyethyl) phosphine (TCEP). The alkylation reagent may be selected from the group consisting of iodoacetamide, chloroacetamide, iodoacetic acid, and acrylamide.

The eluting step may comprise passing an aqueous elution solution through the medium. The aqueous elution solution may comprise (a) 10-100 mM ammonium bicarbonate or Tris(2-carboxyethyl)phosphine (TCEP), (b) 0.05-2% formic acid or acetic acid, (c) 0.05-2% formic acid or acetic acid and 5-95% acetonitrile or methanol, or (d) 5-200 mM ammonium formate, or 1-200 mM ammonium hydroxide at pH 9-11 and 1-90% acetonitrile or methanol.

According to the method, the medium may be in a reaction chamber of a device. The reaction chamber may be formed by a pipette tip, cartridge, multi-well plate, or container. The reaction chamber may further comprise an additional fibrous membrane. The medium may be adhered to a support in the reaction chamber.

### BRIEF DESCRIPTION OF THE DRAWINGS

FIGS. 1A-H show qualitative and quantitative assessment of the E3technology, E3filter, for E. coli proteome analysis. (A-B) Comparison of the number of proteins and peptides between the E3filter, FASP, and glass bead (GB) approaches. Error bars represent three replicates. (C-D) Overlapping analyses of proteins and peptides derived from the three approaches. (E-F) Coefficient of variation of quantified proteins and peptides by the three approaches. (G) Percentages of missed cleavages. (H) Pearson correlation between replicate experiments and different methods.

FIG. 2 shows application of the E3technology to samples of various types. Different formats of E3technology, including pipette tips (named E3tip), 96-well plate (named E3plate) and cartridges (named E3cartridge), were assessed using HeLa cell, mouse kidney, and human saliva specimen, respectively. The number of identified protein groups and unique peptides were plotted.

### DETAILED DESCRIPTION OF THE INVENTION

The present invention provides a medium for preparing samples for proteomic analysis and related the preparation methods. The invention is based on the inventor's surprising discovery that a medium comprising a polytetrafluoroethylene (PTFE) mesh and silica microparticles, for example, glass beads (GBs) provides a platform for rapid and reproducible preparation of peptides from a biological sample. The resulting proteomic sample comprises peptides prepared from the biological sample on the medium are suitable for mass spectrometric analysis with any modification.

The inventor has developed a medium comprising microparticles having a size of 5-50 μm. The microparticles may have been mixed with chromatographic resins, metal oxide, graphene, carbon nanotube, magnetic sphere, polymer or a metal organic frameworks (MOFs). The chromatographic resins may be reversed-phase, ion-exchange, or mixed-mode ion-exchange materials. The metal oxide may be oxide of iron, titanium, aluminum, zirconium, iron, or calcium.

The inventor has also developed a device comprising the medium and a reaction chamber. The reaction chamber may be formed by a pipette tip, cartridge, or multi-well plate, and installed with a medium in the form of a membrane. The biological sample may comprise cellular materials (e.g., mammalian cells, bacteria and virus), tissues, feces and/or body fluids (e.g., urine, blood, saliva, sputum, cerebrospinal fluid, bronchoalveolar lavage fluid, tear, sweat, etc.).

The inventor has further developed a method for preparing peptides from cells, including cell lysis by detergent-based or detergent-free buffer, reduction by dithiothreitol (DTT) or Tris (2-carboxyethyl) phosphine (TCEP), alkylation by iodoacetamide (IAA) or chloroacetamide (CAA), enzymatic digestion by trypsin, Lys-C, chymotrypsin, Glu-C, Arg-C and/or Asp-N, and desalting and fractionation, on a membrane medium, which comprises a polytetrafluoroethylene (PTFE) mesh and silica microparticles. One or multiple stacks of the medium in a device, after packing and assembling, may form a filter unit, and serve as a single-vessel platform for all the reactions in the preparation method. Other types of membrane may be installed underneath the medium to enhance or diversify the process.

The medium, device and the preparation method according to the present invention are collectively referred to as efficient, effective, and economical technology (E3technology). The assembled filter devices, including pipette tips (named E3tip), cartridges (named E3cartridge), and plates (named E3plate), are collectively named E3filter. The inventor has demonstrated that the E3technology outperforms many of the currently available techniques in terms of proteome identification and quantitation. The E3technology is widely applicable, highly reproducible, readily scalable and automatable, as well as user-friendly and stress-free. The E3technology significantly lowers the technical and economical barrier to proteomics experiments, and opens new revenues to sample preparation for clinical proteomics, low input and/or single-cell analysis. The E3technology represents a breakthrough innovation in proteome science, and is anticipated to adopted widely by the proteomics community.

The term “protein” as used herein refers to a molecule having one or more chains of amino acids. The protein may have at least 10 amino acids. The amino acids are linked by a peptide bond or an amide bond. The chain may be branched.

The term “peptides” is used herein generally refers to a fragment of a protein. The peptide may have a chain of 2-10 or 2-30 amino acids. Longer peptides with over 30 amino acids may be generated by digestion of proteins with suitable enzymes. The amino acids are linked by a peptide bond or an amide bond.

The term “proteomic sample” as used herein refers to a sample comprising mainly peptides.

The term “medium” as used herein refers to a fibrous substance. The fibrous substance may form a web. The medium may be in any size or shape. The medium may be a membrane or a composite sheet.

The term “fiber” as used herein refers to a substance having a length substantially longer than its width. For example, the fiber's length may be longer than the fiber's width by at least 5, 10, 50 or 100 folds.

The term “fibrous substance” as used herein refers to a substance formed by fibers. The fibrous substance may comprise one or more other non-fiber components.

The term “fibrous matrix” as used herein refers to a web formed by fibers. The fibrous matrix is porous and permits a fluid to flow through while retaining suspended solids in the fluid that are larger than the pores. The suspended solids may be any particulate matters that are insoluble in a mixture, for example, comprising cells and protein aggregates. The fibrous matrix may be a microporous fiber sheet. A microporous fiber sheet is a thin and flat substance made of fibers and having a porous size in the range of about 0.01-1,000 μm. The fibrous matrix may be inert with respect to a material, for example, chemicals and reagents, used with the fibrous matrix.

The term “silica microparticles” as used herein refers to spherical non-porous glass beads with a major substance of SiO₂. The silica microparticles may comprise one or more other components such as metals. The silica microparticles may have a size of about 0.1-1,000, 0.1-900, 0.1-800, 0.1-700, 0.1-600, 0.1-500, 0.1-400, 0.1-300, 0.1-200, 0.1-100, 0.1-90, 0.1-80, 0.1-70, 0.1-60, 0.1-50, 0.1-40, 0.1-30, 0.1-20, 0.1-10, 0.1-1, 1-1,000, 1-900, 1-800, 1-700, 1-600, 500, 1-400, 1-300, 1-200, 1-100, 1-90, 1-80, 1-70, 1-60, 1-50, 1-40, 1-30, 1-20, 10-1,000, 10-900, 10-800, 10-700, 10-600, 10-500, 10-400, 10-300, 10-200, 10-100, 10-90, 10-80, 10-70, 10-60, 10-50, 10-40, 10-30, 10-20, 20-1,000, 20-900, 20-800, 20-700, 20-600, 20-500, 20-400, 20-300, 10-200, 20-100, 20-90, 20-80, 20-70, 20-60, 20-50, 20-40 or 20-30 μm. The silica particles may be inert with respect to a material, for example, chemicals and reagents, used with the fibrous matrix.

The term “porous” as used herein refers to a substance having pores. The pores may have a size in the range of 0.01-1000 μm.

The term “non-porous” as used herein refers to a substance that is not porous. The non-porous substance do not have pores with a size greater than 0.01 μm.

The term “particulate material” used herein refers to suspended solids, for example, protein aggregates.

The term “non-swellable particulate material” as used herein refers to a particulate material that does not increase in volume by, for example, at least about 5%, 10%, 20%, 50% or 100%, upon exposure to a condition. The condition may be water, heat, light or a combination thereof.

The term “self-supporting” as used herein refers to a property of a material that keeps the integrity of the material upon an impact of a mechanical force. At least about 50%, 60%, 70%, 80%, 90% or 99%, or about 50-100%, 90-100%, 50-99% or 90-99% of the self-supporting material may remain intact, not fall apart. The self-supporting material may be soft and flexible. The self-supporting material may be readily dissembled into various sizes and shapes to fit a reaction chamber of different sizes or shapes.

The term “adhered” as used herein refers to placing onto another surface.

The term “immobilized” as used herein refers to held in place.

The present invention provides a medium. The medium comprises a fibrous matrix and silica microparticles immobilized in the fibrous matrix.

The fibrous matrix may comprise polytetrafluoroethylene (PTFE) fibers, glass fibers, polypropylene fibers, polyolefin fibers, polyvinylidene fluoride (PVDF) fibers, natural cellulosic fibers, polyethylene fibers, aramid fibers, or a combination thereof. In one embodiment, the fibrous matrix comprises PTFE fibers.

The fibrous matrix may have a weight percentage of about 1-10%, 1-20%, 1-50%, 1-60%, 1-70%, 1-80%, 1-90%, 1-95%, 1-99%, 10-20%, 10-50%, 10-60%, 10-70%, 10-80%, 10-90%, 10-95%, 10-99%, 50-60%, 50-70%, 50-80%, 50-90%, 50-95%, 50-99%, 60-70%, 60-80%, 60-90%, 60-95% or 60-99%, based on the total weight of the medium. The fibrous matrix may have a weight percentage greater than about 10%, 20%, 50%, 60%, 70%, 80%, 90%, 95% or 99%, based on the total weight of the medium.

The silica microparticles may be glass beads. The glass beads may be non-porous.

The silica microparticles may have an irregular or a spherical shape. The silica microparticles may have a size of about 0.1-1,000, 0.1-900, 0.1-800, 0.1-700, 0.1-600, 0.1-500, 0.1-400, 0.1-300, 0.1-200, 0.1-100, 0.1-90, 0.1-80, 0.1-70, 0.1-60, 0.1-50, 0.1-40, 0.1-30, 0.1-20, 0.1-10, 0.1-1, 1-1,000, 1-900, 1-800, 1-700, 1-600, 500, 1-400, 1-300, 1-200, 1-100, 1-90, 1-80, 1-70, 1-60, 1-50, 1-40, 1-30, 1-20, 10-1,000, 10-900, 10-800, 10-700, 10-600, 10-500, 10-400, 10-300, 10-200, 10-100, 10-90, 10-80, 10-70, 10-60, 10-50, 10-40, 10-30, 10-20, 20-1,000, 20-900, 20-800, 20-700, 20-600, 20-500, 20-400, 20-300, 10-200, 20-100, 20-90, 20-80, 20-70, 20-60, 20-50, 20-40 or 20-30 μm. The silica particles may be inert with respect to a material, for example, chemicals and reagents, used with the fibrous matrix.

The silica microparticles may have a weight percentage of about 1-10%, 1-20%, 1-50%, 1-60%, 1-70%, 1-80%, 1-90%, 1-95%, 1-99%, 10-20%, 10-50%, 10-60%, 10-70%, 10-80%, 10-90%, 10-95%, 10-99%, 50-60%, 50-70%, 50-80%, 50-90%, 50-95%, 50-99%, 60-70%, 60-80%, 60-90%, 60-95% or 60-99%, based on the total weight of the medium. The silica microparticles may have a weight percentage greater than about 10%, 20%, 30%, 40%, 50%, 60%, 70%, 80%, 90%, 95% or 99%, based on the total weight of the medium.

The medium may further comprise a non-swellable particulate material. The non-swellable particulate material may be pre-mixed with the silica microparticles before the silica microparticles are immobilized in the fibrous matrix or be blended into the medium during the manufacture of the medium with the fibrous matrix and the silica microparticles. Examples of the non-swellable particulate material include chromatographically active materials, metal oxides, graphene, carbon nanotube, polymer, magnetic sphere, metal-organic frameworks (MOFs), and a combination thereof.

The chromatographically active materials are chromatographic sorbents commonly used as a stationary phase in liquid chromatography. Examples of the chromatographically active materials include reversed phase particles (e.g., C4, C8, C18), ion exchange particles and styrenedivinylbenzene-reverse phase sulfonate particles.

Examples of metal oxides include iron oxides, lime, alumina, titania, and zirconia.

The metal-organic frameworks are highly ordered 3-D polymeric open network structures. The metal-organic framework is useful for phosphorylation enrichment.

The medium may be in in any form or shape. The medium may be in the form of a sheet, square, oval, circular disk, or a combination thereof. The medium may be in the form of one or more self-supporting sheets, squares, ovals, circular disks, or combinations thereof. The medium may be in the form of two or more self-supporting sheets, squares, ovals, circular disks, or combinations thereof. The two or more self-supporting sheets may have edges attached. The edges may be attached thermo-mechanically using ultrasonic welding. The medium may be in the form of a multi-layered composite film.

In one embodiment, the medium may be prepared by mixing silica microparticles, for example, glass spheres (SiO₂) (MilliporeSigma), with a PTFE emulsion using techniques known in the art. In the resulting medium, the silica microparticles immobilized in a fibrous matrix of PTFE.

For each medium of the present invention, a composition is provided. The composition comprises a support and the medium adhered to the support. The composition may further comprise an additional fibrous matrix. The additional fibrous matrix may be selected from the group consisting of polyethersulfone (PES) membrane, polytetrafluoroethylene (PTFE) membrane, polyvinylidene fluoride (PVDF) membrane, and a combination thereof.

For each medium of the present invention, a device is provided. The device comprises a reaction chamber and the medium in the reaction chamber.

For each composition of the present invention, a device is provided. The device comprises a reaction chamber and the composition in the reaction chamber.

For each device of the present invention, the reaction chamber may be of any shape. The reaction chamber may be cone-shaped, box-shaped or cylindrical. The reaction chamber may be formed by a pipette tip, cartridge, multi-well plate or container. The container may be cone-shaped, box-shaped or cylindrical. The reaction chamber may have a volume of about 0.01-50, 0.1-50, 1-50, 0.01-20, 0.1-20, 1-20, 0.01-10, 0.1-10, 1-10, 0.01-5, 0.1-5 or 1-5 ml. The reaction chamber may be a pipette tip having a volume of about 10-50, 10-100, 10-150, 10-200, 50-100, 50-150, 50-200, 100-150 or 150-200 μl. The reaction chamber may be a filter having a volume of about 0.01-5, 0.1-5, 1-5, 0.01-1, 0.1-1, 0.01-0.5 or 0.1-0.5 ml. The reaction chamber may be a cartridge having a volume of about 0.01-50, 0.1-50, 1-50, 0.01-20, 0.1-20, 1-20, 0.01-10, 0.1-10, 1-10, 0.01-5, 0.1-5 or 1-5 ml. The reaction chamber may be a well of a culture plate, for example, a 96-well pate, having a volume of about 0.01-10, 0.1-10, 0.2-10, 0.5-10, 1-10, 5-10, 0.01-5, 0.1-5, 0.2-5, 0.5-5, 1-5, 0.01-2, 0.1-2, 0.2-2, 0.5-2 or 1-2 ml.

For each device of the present invention, the reaction chamber may be packed with the medium. The medium may be stacked together and placed into the reaction chamber. The medium may form a filter in the reaction chamber. The medium may remain in the reaction chamber without using any additional accessory (e.g., screw, O-ring, glue or frit), although additional processing such as welding is optional.

The present invention also provides a method for preparing a proteomic sample from proteins in a biological sample on the medium of the present invention. The method comprises (a) treating the biological sample on the medium with a solvent to produce a treatment mixture on the medium, wherein the treatment mixture comprises the proteins on the medium; (b) digesting the proteins on the medium with a proteolytic enzyme to produce peptides on the medium; (c) reducing and alkylating the treatment mixture on the medium; and (d) eluting the peptides from the medium in an elution. As a result, a proteomic sample comprising the eluted peptides is prepared.

The proteomic sample may comprise the eluted peptides in an amount of at least about 90 wt %, 95 wt % or 99 wt % based on the total weight of the desalted proteomic sample. The proteomic sample may comprise an insoluble particle or comprise an insoluble particle at a concentration lower than about 1 wt %, 0.1 wt % or 0.01 wt % based on the total weight of the desalted proteomic sample.

The preparation method may further comprise desalting the proteomic sample. The desalted proteomic sample may comprise the eluted peptides in an amount of at least about 90 wt %, 95 wt % or 99 wt % based on the total weight of the desalted proteomic sample. The desalted proteomic sample may exclude salt or comprise a salt at a concentration lower than about 1 wt %, 0.1 wt % or 0.01 wt % based on the total weight of the desalted proteomic sample. The desalted proteomic sample may comprise an insoluble particle or comprise an insoluble particle at a concentration lower than about 1 wt %, 0.1 wt % or 0.01 wt % based on the total weight of the desalted proteomic sample.

According to the preparation method of the present invention, the proteins may be digested before the treatment mixture is reduced and alkylated.

According to the preparation method of the present invention, the proteins may be digested after the treatment mixture is reduced and alkylated.

The preparation method may further comprise washing the biological sample on the medium. The biological sample may be washed with an organic solvent or digestion-compatible solution. The washing may be carried out before the proteins are digested. The washing removes one or more contaminating or interfering compounds from the medium. Examples of the contaminating or interfering compound may include surfactants used in the lysis buffer such as SDS, urea, NP40, Tween 20, CHAPS, Triton X, etc., salts such as Tris base, sodium chloride, etc., and other reagents added to the proteins before digestion, such as reducing and alkylating reagents.

The proteins in the biological sample may have been solubilized.

The biological sample may comprise a tissue, cell, fungus, virus, body fluid, feces or a combination thereof. Where the biological sample comprises cells and the proteins are in the cells, the method may further comprise extracting the proteins from the cells. The proteins may be extracted from the cells on the medium. Where the biological sample comprises cells and the proteins are in the cells, the method may further comprise fixing the cells.

In the treating step of the preparation method, the solvent may be selected from the group consisting of methanol, ethanol, propanol, chloroform, acetonitrile, acetone, ammonium sulfate, trichloroacetic acid, dimethyl formamide, formaldehyde, and a combination thereof. The treating step may comprise incubating the biological sample with about 50-100% methanol at a temperature of about 0-4° C. for about 0.1-24 hours.

The digesting step may comprise incubating the treatment mixture on the medium with the proteolytic enzyme at a pH of 7-9, 37° C. for 0.5-16 hours. The proteolytic enzyme may be selected from the group consisting of trypsin, Lys-C, chymotrypsin, Glu-C, Arg-C, Asp-N, proteinase K, elastase, and a combination thereof.

The reducing and alkylating step may comprise subjecting the treatment mixture on the medium to a reducing reagent and an alkylation reagent, simultaneously or sequentially. The reducing reagent may be dithiothreitol, beta-mercaptoethanol, Tris(2-carboxyethyl) phosphine (TCEP) or a combination thereof. The alkylation reagent may be iodoacetamide, chloroacetamide or a combination thereof.

The eluting step may comprise passing an aqueous elution solution through the medium. The aqueous elution solution may comprise art-established eluents, for example, (a) 10-100 mM ammonium bicarbonate or Tris(2-carboxyethyl) phosphine (TCEP), (b) 0.05-2% formic acid or acetic acid, (c) 0.05-2% formic acid or acetic acid and 5-95% acetonitrile or methanol, or (d) 5-200 mM ammonium formate, or 1-200 mM ammonium hydroxide at pH 9-11 and 1-90% acetonitrile or methanol. Centrifugation, vacuum or positive pressure may be applied to the facilitate liquid transfer of aqueous elution solution through the medium.

The eluting step may be repeated one or more times to produce one or more additional elution. The elution may be combined into the proteomic sample to pool the peptides prepared from the biological sample.

According to the preparation method of the present invention, the medium may be in a reaction chamber of a device. The medium may be adhered to a support in the reaction chamber. The reaction chamber may be formed by a pipette tip, cartridge, multi-well plate, or container. The container may be cone-shaped, box-shaped or cylindrical. The reaction chamber may further comprise an additional fibrous membrane. The additional fibrous matrix may be selected from the group consisting of polyethersulfone (PES) membrane, polytetrafluoroethylene (PTFE) membrane, polyvinylidene fluoride (PVDF) membrane, and a combination thereof. The reaction chamber may be formed by a pipette tip, cartridge, or multi-well plate.

The term “about” as used herein when referring to a measurable value such as an amount, a percentage, and the like, is meant to encompass variations of ±20% or ±10%, more preferably ±5%, even more preferably ±1%, and still more preferably ±0.1% from the specified value, as such variations are appropriate.

### Example 1. Biological Sample Collection

Fresh cell pellets of HEK293, HeLa, E. coli and yeast cells, mouse tissue samples (e.g., kidney, heart, etc.), and human saliva specimens were collected following art-established procedures. In brief, the mammalian, bacterial or fungi cells were grown in preferred culturing media, pelleted by centrifugation at 5,000 rpm for 10 min. The cell pellets were washed with cold phosphate-buffered saline (PBS) and pelleted again after discarding supernatant.

### Example 2. Non-Detergent Based Cell Lysis and Protein Digestion

The cell pellets collected in Example 1 were mixed with 4× volume of 100% trifluoroacetic acid (TFA), vortexed for a few seconds, and incubated at room temperature for 3-5 min to lysis cells. Cold acetone was added at 6× volume of the lysate to precipitate proteins. The protein precipitates were transferred to an E3filter, and spun at 2,000 rpm for 1-2 min. The E3filter was washed with 200 μl 80% acetone for 2-3 times, and then with 200 μl 50 mM Triethylamonium bicarbonate (TEAB) for 1-2 times. The washed E3filter was then incubated with 10 mM Tris (2-carboxyethyl) phosphine (TCEP) and 40 mM chloroacetamide (CAA) at 70° C. for 30 min to reduce and alkylate the proteins on the E3filter, respectively. The E3filter was then washed again with 200 μl 50 mM TEAB for 1-2 times to remove residual TCEP and CAA. The proteins on the E3filter were then incubated with a digestion enzyme (e.g., trypsin) at a weight ratio of the enzyme to the proteins from 1:10 to 1:100 in a digestion buffer, for example, 20-100 mM ammonium bicarbonate (ABC) or TEAB, in a Thermomixer®) at 500 rpm at 37° C. for 16 h. To elute the peptides from the E3filter, 200 μl of 50 mM TEAB with 0.1% formic acid in water was applied to the E3filter before the E3filter was spun at 2000 rpm for 1 min to collect an elution. Then, 200 μl of 50 mM TEAB with 50% acetonitrile/0.1% formic acid in water was applied to the E3Filter before the E3filter was spun to collect another elution. The collected elution was pooled and dried with SpeedVac to obtain dried peptides.

### Example 3. SDS Detergent-Based Cell Lysis and Protein Digestion

The cell pellets or tissue samples prepared in Example 1 were mixed with 50-100 μl of 5% SDS in 100 mM Tris-HCI, pH 8.0, and then vortexed for 10-20 minutes. Probe-based sonication, or bead beater may be used here to facilitate the lysis of the cells. Lysate was cleared by centrifugation at 14,000 rpm for 10 min at 4° C., and the lysate in the supernatant was collected. The lysate was boiled with 10 mM TCEP and 40mM CAA at 95° C. for 5-10 min.

A human saliva specimen was collected following a protocol described previously by Lin et al. (J. Proteome Res. 2019, 18, 1907-1915). The donor of the human saliva specimen was asked to avoid eating, drinking, or smoking for at least 60 min prior to saliva collection. After the mouth was rinsed with water, up to 5 mL of unstimulated whole saliva sample was collected by draining directly into a 15-ml falcon tube. The sample was first centrifuged at 2600 g for 20 min at 4° C. to remove residual food and cell debris. The supernatant was then collected as lysate. The lysate was mixed with SDS buffer (5% SDS in 100 mM Tris-HCI, pH 8.0).

To proceed with enzymatic digestion, 1/10 volume of 12% phosphoric acid was added to the lysate, and then 6× volume of 90% methanol and 50 mM TEAB were added. Alternatively, 4× 80% acetonitrile was added to the lysate. As a result, protein precipitates were obtained.

The protein precipitates were transferred to an E3filter, and spun at 4,000 rpm for 1-2 min. The proteins on the E3filter were washed with 200 μl of either 90% methanol and 50 mM TEAB or 80% acetonitrile for 2-3 times. The washed proteins on the E3filter were then incubated with a digestion enzyme, e.g., trypsin, at a weight ratio of the enzyme to the proteins from 1:10 to 1:100 in 20-100 mM ABC or TEAB in a Thermomixer at 500 rpm, 37° C. for 16 h.

To elute the peptides from the E3filter, 200 μl of 50 mM TEAB with 0.1% formic acid in water was applied to the E3filter before the E3filter was spun at 2000 rpm for 1 min to collect an elution. Then, 200 μl of 50 mM TEAB with 50% acetonitrile/0.1% formic acid in water was applied to the E3Filter before the E3filter was spun to collect another elution. The collected elution was pooled and dried with SpeedVac to obtain dried peptides.

### Example 4. Direct Digestion of Cells Fixed With Methanol

An aliquot of cell pellets prepared in Example 1 was placed into a E3filter, mixed with 90% methanol at final concentration, and incubated on ice for about 30 min. The E3filter was spun at 4,000 rpm for 2-3 min, washed with 90% methanol 1-2 times by spinning. Then, washed cells on the E3filter were incubated with a digestion enzyme, e.g., trypsin, at a weight ratio of the enzyme to the proteins from 1:10 to 1:100 in 20-100 mM ABC or TEAB in a Thermomixer at 500 rpm, 37° C. for 16 h. After digestion, the resulting peptides on the E3filter were incubated with 10 mM Tris (2-carboxyethyl) phosphine (TCEP) and 40 mM chloroacetamide (CAA) at 70° C. for 30 min. to reduce and alkylate the proteins on the E3filter, respectively. To elute peptides, sequential elution buffers as described above were applied. The pooled elution was then desalted and dried by SpeedVac before LC-MS/MS analysis.

### Example 5. Peptide Desalting and Fractionation

The protein digests obtained from Example 2 or 3, using a E3filter packed with hybrid GB/C18 membrane (GB:C18 beads=1:1, by weight), was first acidified with 2% acetic acid, then spun at 4000 rpm for 1-2 min followed by spinning 200 μl of 0.5% acetic acid for 1-2 times. The peptides were then eluted with 200 μl of 60% and 80% acetonitrile, respectively. The pooled elution was dried with a SpeedVac.

For peptide fractionation, the above protein digests protein digests on the GB/C18 membrane based E3filter were first adjusted to contain 25 mM ammonium hydroxide. The peptides were then eluted sequentially with 200 μl of 25 mM ammonium hydroxide plus acetonitrile gradient (5/7/9/12/15/18/20/25/30/40/80% acetonitrile). Eleven fractions were collected and then pooled to become six fractions following a strategy described in the study by Wang et al. (Proteomics, 11 (2011), pp. 2019-2026). The fractions were dried, and then desalted by C18-based StageTip as described by Yu et al. (Methods Mol Biol. 2019;2021:259-272. doi: 10.1007/978-1-4939-9601-8_22) before LC-MS/MS analysis.

### Example 6. Phosphorylation Enrichment

For enrichment of phosphopeptides, six layers of GB/TiO2 membrane (GB:TiO2=1:1, by weight) were packed into 200 μl pipette tips. The tips were first activated with 200 μl of 100% acetonitrile (ACN), and centrifuged at 3,000× g for 1-2 min to remove the ACN. The dried peptides obtained from Examples 2, 3 or 4 were resuspended with 200 μl of loading buffer (60% acetonitrile, 5% trifluoroacetic acid, TFA), sonicated for 3 min with water bath, and centrifuged at max speed for 10 min to pellet insoluble particles. The supernatant was then loaded onto a tip packed with GB/TiO2 membrane and centrifuged at 500× g for 6-10 min until all of the liquid passed through the membrane. The membrane was washed twice with 200 μl wash buffer (80% ACN, 2% TFA) and centrifuged at 3,000× g for 1-2 min. Phosphopeptides were eluted with 90 μl elution buffer (40% ACN, 15% NH₄OH), and collected by centrifugation at 500× g for 6-10 min. A basic elution buffer was neutralized with 9 μl formic acid and desalted by C18-based StageTip as described by Yu et al. (Methods Mol Biol. 2019;2021:259-272. doi: 10.1007/978-1-4939-9601-8_22) before LC-MS/MS analysis.

### Example 7. Qualitative and Quantitative Evaluation of E3technology Using E. Coli Proteome

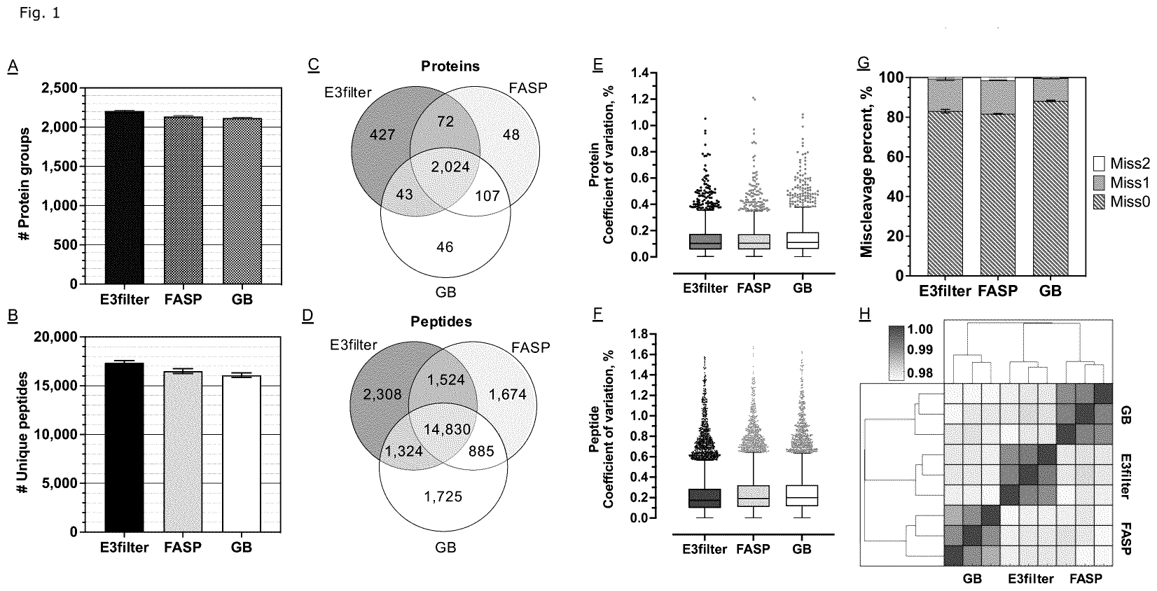

The proposed technology has been tested using a standard E. coli proteome. The E. coli cells were lysed using SDS-based buffer outside the filter. Around 20-30 μg of protein aliquots were transferred to E3filters, and mixed with an organic solvent (80% acetonitrile). The following steps including depletion, reduction, alkylation, protein cleanup and digestion were all carried out in the filters. The resulting peptides were analyzed by LC-MS/MS without any additional preparation. In the meantime, the E3filter method was compared with two established methods that are based on molecular weight cut-off membrane (FASP) and pure glass beads (GB) (FIG. 1). These procedures were followed according to Johnston's study (Anal. Chem. 2022, 94, 29, 10320-10328).

The comparative results demonstrate that E3technology could consistently identify more proteins and peptides than the art-established methods with high efficiency and effectiveness, allowing the sample processing to be completed within minutes, and the majority of the peptides (˜83%) to be effectively cleaved. The identifications shared significant overlaps as well, which suggested the unbiased nature of the E3technology. Excellent quantitative reproducibility was also observed with high correlations and low variations between the replicate experiments.

Although FASP has been one of the most widely adopted preparation methods in the past decade by the proteomics community, the liquid transfer through the FASP membrane is notoriously slow. The overall processing time could take up to 200 minutes. By contrast, the E3technology is extremely rapid, ten time less (˜20 min) processing time is needed. On the other hand, the free-bead method GB, although straightforward, requires expert knowledge and fine tuning of the procedures, such as minimum protein concentration, protein-bead ratios, pH, and extra cautions to potential sample losses due to disaggregation and resuspension of protein aggregates and clumping beads, fragile or dense aggregates, and even non-elegant pipetting.

By immobilizing GBs onto PTFE mesh, E3technology significantly lowers the technical barrier to proteomics sample preparation, and creates a truly simple and straightforward approach for researchers with different levels of expertise.

### Example 8. Testing E3technology Using Various Sample Types

As the effectiveness of E3technology has been demonstrated for E. coli cells, we extended this further to other sample types. In this demonstration, we examined mammalian cells, mouse kidney tissue, and human saliva with varied sample quantities and volumes. We also tested different formats of E3technology by packing the said medium of this invention into pipette tips (200-μl maximum volume), cartridges (1-3 ml maximum volume), and a 96-well plate (500-μl maximum volume). The samples were processed following the same procedures as described in Example 3.

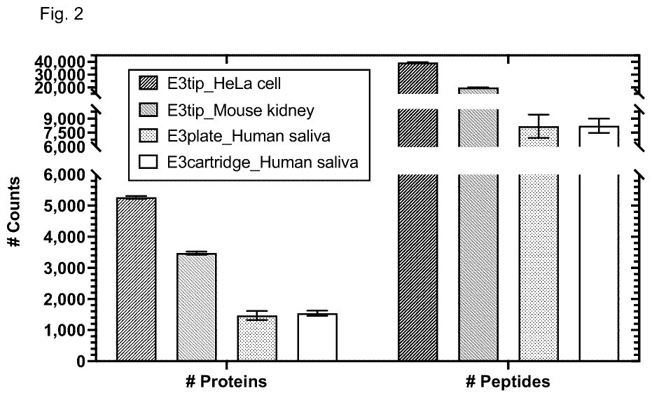

The results (FIG. 2) show that E3technology is versatile and broadly applicable to a wide range of biological samples. It can process large volumes (>5 ml) in case samples are diluted. It is readily scalable and automatable in the format of multi-well plate, highlighting its great potential for clinical proteomics analysis, where large sample cohorts are usually involved.

All documents, books, manuals, papers, patents, published patent applications, guides, abstracts, and/or other references cited herein are incorporated by reference in their entirety. Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

1. A medium comprising a fibrous matrix and silica microparticles immobilized in the fibrous matrix.

2. The medium of claim 1, wherein the fibrous matrix comprises polytetrafluoroethylene (PTFE) fibers, glass fibers, polypropylene fibers, polyolefin fibers, polyvinylidene fluoride (PVDF) fibers, natural cellulosic fibers, polyethylene fibers, aramid fibers, or a combination thereof.

3. The medium of claim 1, wherein the silica microparticles are non-porous glass beads.

4. The medium of claim 1, wherein the silica microparticles have an irregular shape or a spherical shape.

5. The medium of 1, wherein the silica microparticles have a size of 0.1-600 micrometers.

6. The medium of claim 1, wherein the silica microparticles have a weight percentage of greater than 30% based on the total weight of the medium.

7. The medium of claim 1, further comprising a non-swellable particulate material.

8. The medium of claim 1, wherein the medium is in the form of a sheet, square, oval, circular disk, or a combination thereof.

9. The medium of claim 1, wherein the medium is in the form of one or more self-supporting sheets, squares, ovals, circular disks, or combinations thereof.

10. The medium of claim 1, wherein the medium is in the form of two or more self-supporting sheets, squares, ovals, circular disks, or combinations thereof.

11. The medium of claim 10, wherein the two or more self-supporting sheets, squares, ovals, circular disks, or combinations thereof have edges attached.

12. The medium of claim 1, wherein the medium is in the form of a multi-layered composite film.

13. A composition comprising a support and the medium of claim 1 adhered to the support.

14. The composition of claim 13, further comprising an additional fibrous matrix.

15. A device comprising a reaction chamber and the medium of claim 1 in the reaction chamber.

16. The device of claim 15, wherein the reaction chamber is formed by a pipette tip, cartridge, multi-well plate, or container.

17. A method for preparing a proteomic sample from proteins in a biological sample on the medium of claim 1, comprising:
(a) treating the biological sample on the medium with a solvent to produce a treatment mixture on the medium, wherein the treatment mixture comprises the proteins on the medium;
(b) digesting the proteins on the medium with a proteolytic enzyme to produce peptides on the medium;
(c) reducing and alkylating the treatment mixture on the medium; and
(d) eluting the peptides from the medium in an elution, whereby a proteomic sample comprising the eluted peptides is prepared.

18. The method of claim 17, further comprising desalting the proteomic sample.

19. The method of claim 17, wherein the proteins are digested before the treatment mixture is reduced and alkylated.

20. The method of claim 17, wherein the proteins are digested after the treatment mixture is reduced and alkylated.

21. The method of claim 17, further comprising washing the biological sample on the medium.

22. The method of claim 17, further comprising repeating the eluting step one or more times to produce one or more additional elutions.

23. The method of claim 17, wherein the biological sample comprises cells and the proteins are in the cells, the method further comprising extracting the proteins from the cells.

24. The method of claim 23, wherein the proteins are extracted from the cells on the medium.

25. The method of claim 17, wherein the biological sample comprises cells and the proteins are in the cells, the method further comprising fixing the cells.

26. The method of claim 17, wherein the solvent is selected from the group consisting of methanol, ethanol, propanol, chloroform, acetonitrile, acetone, ammonium sulfate, trichloroacetic acid, dimethyl formamide, formaldehyde and a combination thereof.

27. The method of claim 17, wherein the treating step comprises incubating the biological sample with a solvent at a temperature of 0-4° C. for 0.1-24 hours.

28. The method of claim 17, wherein the proteolytic enzyme is selected from the group consisting of trypsin, Lys-C, chymotrypsin, Glu-C, Arg-C, Asp-N, proteinase K, elastase, and a combination thereof.

29. The method of claim 17, wherein the reducing and alkylating step comprises subjecting the treatment mixture on the medium to a reducing reagent and an alkylation reagent.

30. The method of claim 29, wherein the reducing reagent is dithiothreitol, beta-mercaptoethanol or Tris(2-carboxyethyl) phosphine (TCEP).

31. The method of claim 29, wherein the alkylation reagent is selected from the group consisting of iodoacetamide, chloroacetamide, iodoacetic acid, and acrylamide.

32. The method of claim 17, wherein the eluting step comprises passing an aqueous elution solution through the medium.

33. The method of claim 32, wherein the aqueous elution solution comprises (a) 10-100 mM ammonium bicarbonate or Tris(2-carboxyethyl) phosphine (TCEP), (b) 0.05-2% formic acid or acetic acid, (c) 0.05-2% formic acid or acetic acid and 5-95% acetonitrile or methanol, or (d) 5-200 mM ammonium format, or 1-200 mM ammonium hydroxide at pH 9-11 and 1-90% acetonitrile or methanol.

34. The method of claim 17, wherein the medium is in a reaction chamber of a device.

35. The method of claim 34, wherein the reaction chamber is formed by a pipette tip, cartridge, multi-well plate, or container.

36. The method of claim 34, wherein the reaction chamber further comprises an additional fibrous membrane.

37. The method of claim 34, wherein the medium is adhered to a support in the reaction chamber.
